(19) United States
(12) Patent Application Publication
(10) Pub. No.: US 2007/0081077 A1
(43) Pub. Date: Apr. 12, 2007

(54) Receiver for subject insertable device

(75) Inventor: Akira Matsui, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/545,365

(22) Filed: Oct. 10, 2006

Related U.S. Application Data
(63) Continuation of application No. PCT/JP04/19244, filed on Dec. 22, 2004.

(30) Foreign Application Priority Data
Apr. 8, 2004 (JP) 2004-114355

(51) Int. Cl. H04N 7/18

(52) U.S. Cl. 348/77

(57) ABSTRACT

A receiver is carried by a subject and receives a radio signal transmitted from a transmitter introduced into the subject. The receiver includes an acquiring unit that acquires specific identification information of the subject; a storage unit that stores the identification information acquired by the acquiring unit; and a display unit that displays the identification information stored in the storage unit.

### CROSS-REFERENCE TO RELATED APPLICATIONS

This application is a continuation of PCT international application Ser. No. PCT/JP2004/019244 filed Dec. 22, 2004 which designates the United States, incorporated herein by reference, and which claims the benefit of priority from Japanese Patent Application No. 2004-114355, filed Apr. 8, 2004, incorporated herein by reference.

### BACKGROUND OF THE INVENTION

1. Field of the Invention

The present invention relates to a receiver that receives a radio video signal transmitted from a subject insertable device which is introduced into a subject, e.g., a swallowable-type capsule endoscope, with plural antenna elements arranged outside the subject.

2. Description of the Related Art

In recent years, a swallowable-type capsule endoscope that is equipped with an imaging function and a radio communication function emerges in the field of endoscope. The capsule endoscope is swallowed by the subject from a mouth for an observation (examination). After being swallowed, the capsule endoscope moves through inside body cavities, for example, internal organs such as a stomach and a small intestine, with peristaltic motion inside the subject, and sequentially picks up images inside the body cavities until being naturally discharged.

While moving through the body cavities, the capsule endoscope sequentially transmits data of the picked-up images of the inside to the outside by radio communication. The transmitted data is stored in a memory of an external receiver. After swallowing the capsule endoscope, the subject carries the receiver which has radio communication function and memory function until the capsule endoscope is discharged, and can move freely. After the capsule endoscope is discharged, a doctor or a nurse can retrieve the image data stored in the memory of the receiver and watch images of the internal organs on a display monitor to make diagnosis.

The receiver generally includes plural antenna elements dispersed outside the subject and selects an antenna element having less receiving errors from the plural antenna elements to receive a video signal transmitted from the capsule endoscope. For example, a receiver disclosed in JP-A No. 2003-19111 (KOKAI) switches over plural antenna elements dispersed outside a subject and detects the position of a capsule endoscope, which is a video signal source, in the subject based on difference in strength of a received radio signal at respective antenna elements.

### SUMMARY OF THE INVENTION

According to one aspect of the present invention, a receiver is carried by a subject, receives a radio signal transmitted from a transmitter introduced into the subject, and includes an acquiring unit that acquires specific identification information of the subject; a storage unit that stores the identification information acquired by the acquiring unit; and a display unit that displays the identification information stored in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an overall structure of a wireless intra-subject information acquiring system that includes a receiver according to a first embodiment;

FIG. 2 is a schematic diagram of the receiver shown in FIG. 1;

FIG. 3 is a block diagram of the receiver;

FIG. 4 shows some items of identification information displayed on a display unit of an external device shown in FIG. 2;

FIG. 5 is a flowchart of an examination procedure using a capsule endoscope shown in FIG. 1; and

FIG. 6 shows another connection of the receiver and a display device which are both shown in FIG. 1.

### DETAILED DESCRIPTION OF THE PREFERRED EMBODIMENTS

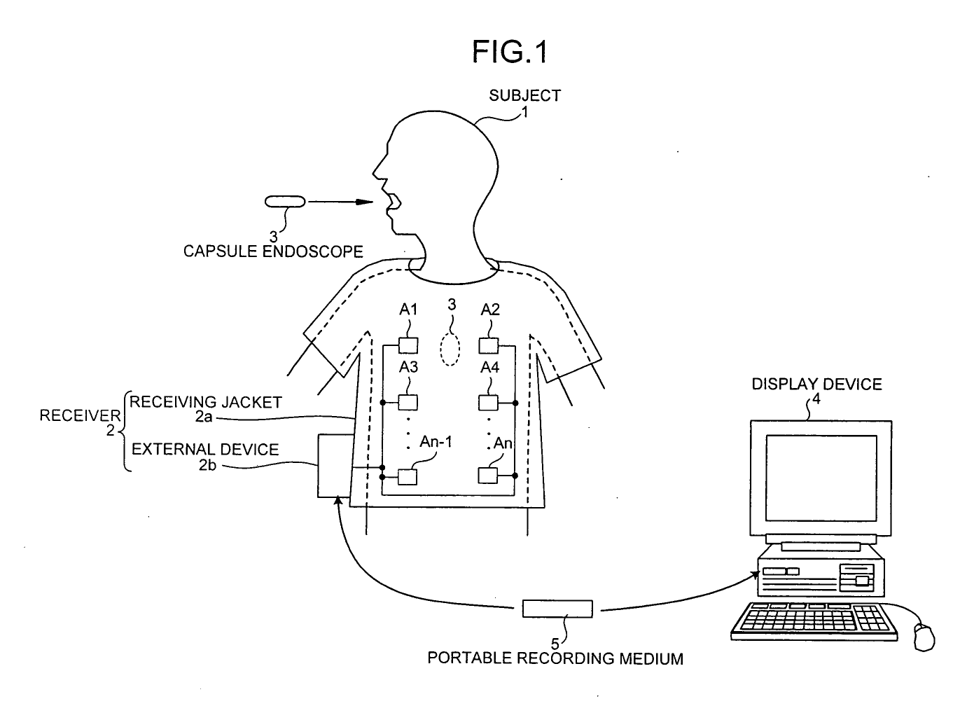

Exemplary embodiments of a receiver according to the present invention will be described in detail below with reference to FIGS. 1 to 6. It should be noted that the present invention is not limited to the embodiments, and therefore, various modifications may be made without departing from the scope of the general inventive concept.

FIG. 1 is a schematic diagram of an overall structure of a wireless intra-subject information acquiring system that includes a receiver according to a first embodiment. In FIG. 1, the wireless intra-subject information acquiring system includes a receiver 2 that has a radio receiving function; and a capsule endoscope (subject insertable device) that is introduced into a subject 1 and captures an image inside a body cavity to transmit data such as a video signal to the receiver 2. The wireless intra-subject information acquiring system also includes a display device 4 that displays a body cavity image based on a video signal received by the receiver 2; and a portable recording medium 5 that exchanges data between the receiver 2 and the display device 4. The receiver 2 includes a receiving jacket 2a that is worn by the subject 1; and an external device 2b that processes a radio signal received.

The display device 4 displays, for example, a body cavity image captured by the capsule endoscope 3, and has a configuration for displaying an image based on data obtained from the portable recording medium 5, e.g., a configuration of a workstation. Specifically, the display device 4 may have a configuration of a device that directly displays an image, such as a CRT and an LCD, or a configuration of a device that outputs an image onto a specific medium, such as a printer.

The portable recording medium 5 is detachable to the external device 2b and the display device 4, and has a configuration that outputs or records data when inserted into the devices. In this embodiment, the portable recording medium 5 is inserted into the display device 4 of the workstation to stored identification information such as an examination ID before examination, and is inserted into the external device 2b immediately before the examination, so that the external device 2b reads out and stores the identification information. The portable recording medium 5 is inserted into the external device 2b attached to the subject 1 and stores data transmitted from the capsule endoscope 3 while the capsule endoscope 3 moves through the body cavity of the subject 1. The portable recording medium 5 is then removed from the external device 2b and inserted into the display device 4 after the capsule endoscope 3 is discharged from the subject, in other words, after capturing the body cavity image of the subject 1 is completed. The display device 4 reads out data stored in the portable recording medium 5. The portable recording medium 5 is configured to be used in such a manner. Exchanging data between the external device 2b and the display device 4 by the portable recording medium 5 such as CompactFlash® memory allows the subject 1 to move freely during capturing of the body cavity image, compared with exchanging data through a cable directly connecting them. Although the portable recording medium 5 is used in exchanging data between the external device 2b and the display device 4 here, the exchanging is not necessary in such a manner. For example, a built-in storage device such as a hard disk drive is used as the external device 2b; data is exchanged between the display device 4 and the built-in storage device through wired or wireless connection.

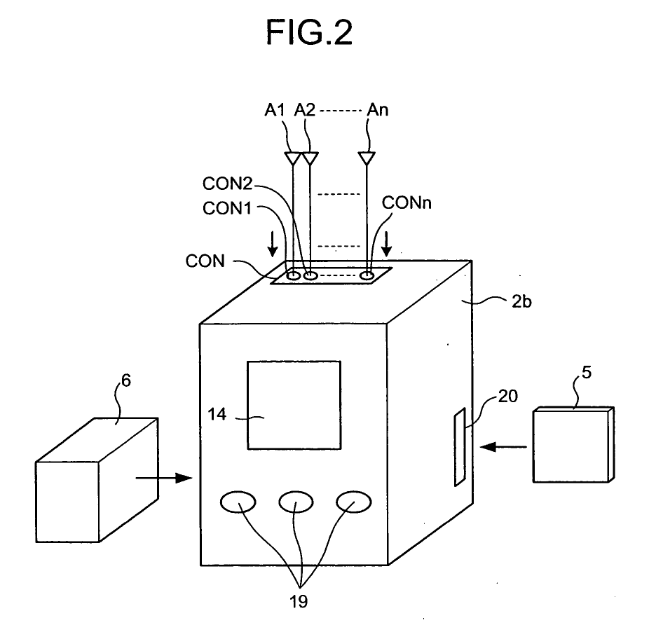

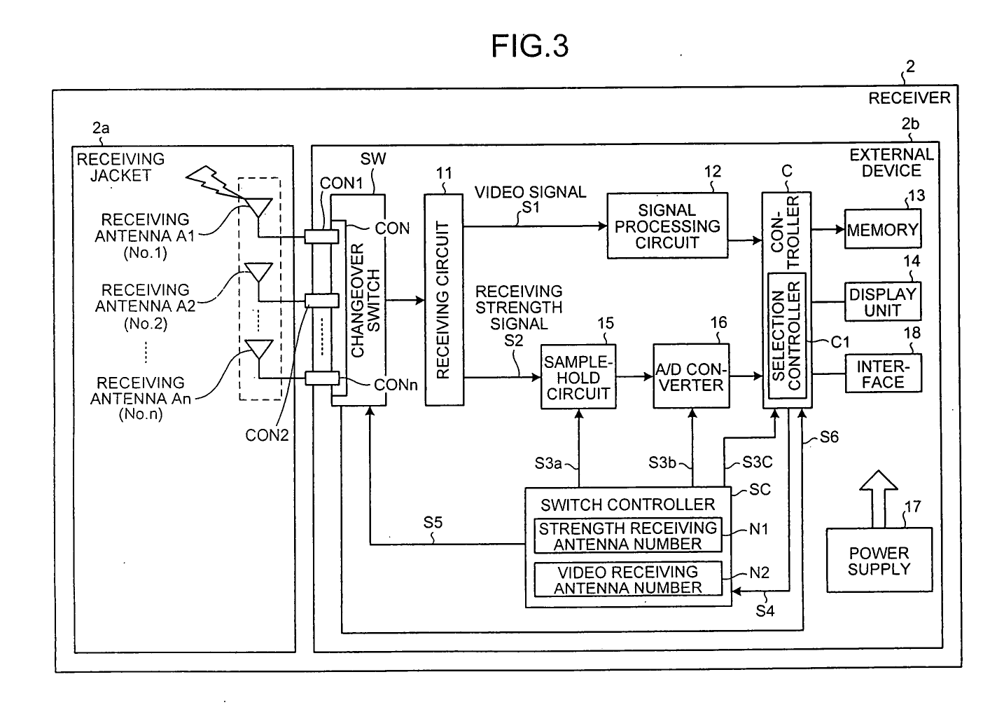

A configuration of the receiver 2 is described below with reference to the schematic diagram of FIG. 2 and the block diagram of FIG. 3. The receiver 2 has a function that receives body cavity image data wirelessly transmitted from the capsule endoscope 3. As shown in FIGS. 2 and 3, the receiver 2 has a wearable shape for the subject 1 and includes the receiving jacket 2a with receiving antennas A1 to An, and the external device 2b that processes a radio signal received through the receiving jacket 2a. The respective receiving antennas A1 to An may be not provided in the receiving jacket 2a, and be attached directly to the outer surface of the subject 1 or be detachable to the receiving jacket 2a.

A battery pack 6 that houses a battery for power supply is connected to the outer surface of the external device 2b as shown in FIG. 2. When the battery pack 6 is connected to the external device 2b, the battery is electrically connected to internal components, described below, of the external device 2b and thus allows power supply for the internal components. A display unit 14, for example, an LCD is mounted on the front face of the outer surface to display identification information such as the recorded examination ID. An operation switch 19 serving as an instruction unit is mounted on the front face of the outer surface, thereby allowing the user to select information to be displayed on the display unit 14 or adjust color tone of the display unit 14. An insertion port 20 for the portable recording medium 5 is formed in the side face of the outer surface, and holds the inserted portable recording medium 5 so that the inserted portable recording medium 5 is detachable, thereby allowing the external device 2b to record the image data. A connecting unit CON for connecting the receiving antennas A1 to An is mounted on the top face of the outer surface. The respective receiving antennas A1 to An have connectors CON1 to CONn which are connected to the connecting unit CON.

The external device 2b has a function that processes a radio signal transmitted from the capsule endoscope 3. Specifically, as shown in FIG. 3, the external device 2b includes a changeover switch SW that changes the connection of the receiving antennas A1 to An; a receiving circuit 11 that is connected to the output port of the changeover switch SW and amplifies and demodulates a radio signal from one of the receiving antennas A1 to An the connection of which is changed by the changeover switch SW; and a signal processing circuit 12 and a sample-hold circuit 15 which are both connected to the output port of the receiving circuit 11. An A/D converter 16 is connected to the output port of the sample-hold circuit 15.

A controller C includes a selection controller C1 serving as a control unit, and is connected to the signal processing circuit 12, the A/D converter 16, a memory 13 corresponding to the portable recording medium 5, the display unit 14, and a switch controller SC. The switch controller SC stores strength receiving antenna numbers N1 and video receiving antenna numbers N2, sends a changing instruction to the changeover switch SW with the these numbers, and determines respective processing timings for the sample-hold circuit 15, the A/D converter 16, and the selection controller C1. The controller C also includes an internal memory (not shown), records, in the internal memory serving as a memory unit, identification information stored in the memory 13, and displays a specific identification information item (hereinafter, referred to as “specific information”) selected from the identification information on the display unit 14. In other words, the controller C also functions as an acquiring unit that acquires the identification information and a display control unit that displays the specific information on the display unit 14. A power supply 17 consists of the battery contained in the battery pack 6 to supply power to the internal components.

The changeover switch SW of the external device 2b outputs a radio signal from the receiving antennas A1 to An to the receiving circuit 11 based on the changing instruction by the switch controller SC. The changeover switch SW includes the connecting unit CON serving as an antenna switch unit that changeovers the receiving antennas A1 to An at the corresponding positions, respectively.

In FIG. 3, the receiving circuit 11 amplifies and demodulates the radio signal, outputs a resulting signal as a video signal S1 to the signal processing circuit 12, and outputs, to the sample-hold circuit 15, another resulting signal as a receiving strength signal S2 that indicates a received electric field strength of the amplified radio signal. The video data that is processed by the signal processing circuit 12 is stored in the memory 13 by the controller C, and is output to the display unit 14. The signal sample-held by the sample-hold circuit 15 is converted into a digital signal by the A/D converter 16 and then received by the controller C. The controller C selects a receiving antenna that receives a signal with the largest received electric field strength as a receiving antenna in a video signal period, and sequentially selects the receiving antennas other than the selected receiving antenna as a receiving antenna in a strength signal period. The controller C then outputs, to the switch controller SC, a signal S4 that sets the respective numbers of the receiving antennas as the video receiving antenna number N2 and the strength receiving antenna number N1. Here, the selection controller C1 sets a receiving antennas as being a selection target from only the receiving antennas A1 to An that have been selected based on a signal S6. The controller C stores the received electric field strength in the strength receiving period and the received electric field strength in the video receiving period in association with the receiving antennas selected in the respective periods, together with the video data, in the memory 13. The stored received electric field strengths of the respective receiving antennas are used as information for calculating a position of the capsule endoscope 3 in the body cavity at reception of the video data.

The switch controller SC holds the strength receiving antenna number N1 and video receiving antenna number N2 that are specified by the selection controller C1, outputs a signal S5 to the changeover switch SW. The signal S5 indicates an instruction for selecting one of the receiving antennas A1 to An corresponding to the strength receiving antenna number N1 during the strength receiving period or an instruction for selecting one of the receiving antennas A1 to An corresponding to the video receiving antenna number N2 during the video receiving period. The switch controller SC also outputs a signal S3a that indicates an instruction of a sample-hold timing of the sample-hold circuit 15, a signal S3b that indicates an instruction of an A/D conversion timing of the A/D converter 16, and a signal S3c that indicates an instruction of a selection control timing of the selection controller C1.

The identification information recorded by the controller C includes, for example, information about face of the subject in addition to examination ID such as examination date; and name, age, and sex of the subject. The information about face of the subject may include not only image data but also face features of the subject, such as round or long, position of a unique spot, and eye color and hair color if the subject is westerner. The face image data can be acquired by an image capturing device (not shown) connected to the display device 4 of the workstation, such as an image scanner.

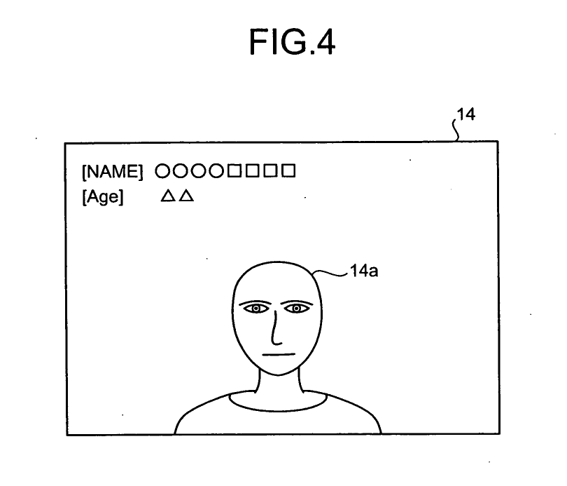

An operator such as a doctor selects a predetermined item or a specific item of the identification information with the operation switch 19 to display the item on the display unit 14. FIG. 4 shows some items of identification information displayed on the display unit 14 of the external device 2b. In FIG. 4, [NAME] and [Age] that indicate features of the subject, and face image data 14a are selected as specific information being a comparison target and displayed. The operator such as the doctor compares the specific information displayed on the display unit 14, particularly, the face image data 14a, with a subject to which the receiver 2 is attached, to identify the correct subject, thereby avoiding misidentification of subjects. Selecting the specific information from the identification information is not limited to the manual manner as described above. For example, type of the specific information to be displayed is in advance set by an input device such as a keyboard; the controller C automatically selects the set specific information from the identification information stored in the internal memory based on the type, and controls the display unit 14 to display the selected specific information. The specific information is not limited to examples described in this embodiment, and may be only face image data, only name and age information, or other identification information of a subject.

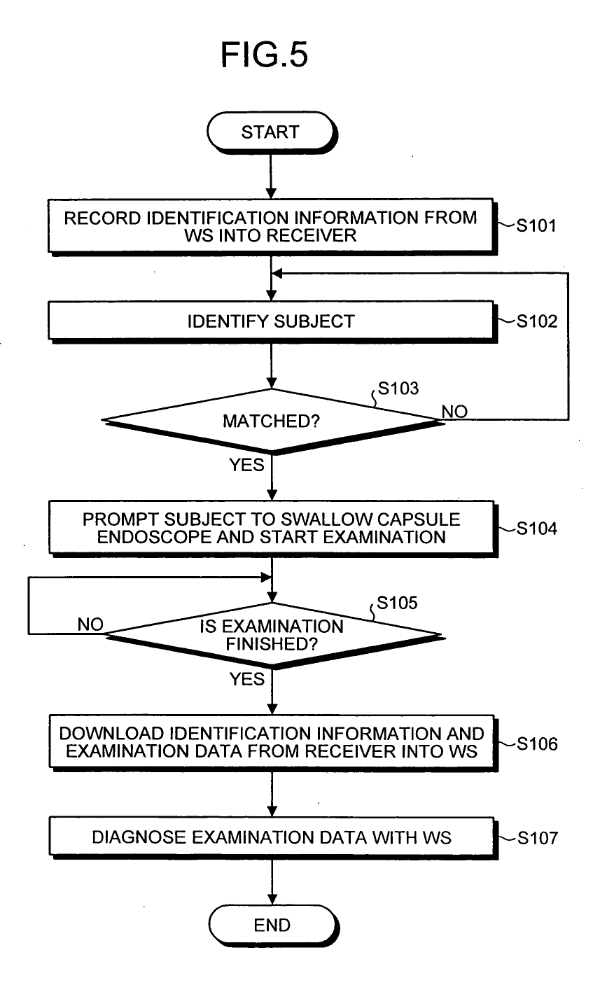

An examination procedure using the capsule endoscope 3 shown in FIG. 1 is described below with reference to the flowchart of FIG. 5. In FIG. 5, the display device 4 of the workstation first stores identification information in the portable recording medium 5 inserted thereinto; the portable recording medium 5 is then inserted into the external device 2b of the receiver 2, and thus the identification information in the portable recording medium 5 is read out and recorded in the internal memory of the external device 2b (step 101). After that, an operator such as a doctor displays the specific information, as being a comparison target, of the recorded identification information to identify the subject (step 102), thereby determining whether the specific information matches with the subject (step 103).

When the specific information does not match with the subject, the procedure is returned to step 102 to identify other subject. When the specific information matches with the subject, the subject is prompted to swallow the capsule endoscope 3 to start the examination of the body cavity (step 104), and it is then determined whether the examination is completed (step 105). During the examination, data transmitted from the capsule endoscope 3 are sequentially stored in the memory 13 by a writing control of the controller C. As a result, in this period, the subject can act freely without inconvenience.

When the capsule endoscope 3 is discharged from the subject 1, so that the examination of the body cavity is completed, the portable recording medium 5 is removed from the external device 2b and then inserted into the display device to download the examination data (identification information and image data) stored in the portable recording medium 5 (step 106). The downloaded examination data is displayed on a display screen of the display device 4, so that the body cavity is diagnosed (step 107).

As described above, in this embodiment, specific information that indicates features of the subject is selected from the identification information stored in the receiver to be displayed on the display unit of the receiver, thereby allowing identification of the actual subject. As a result, when the receiver is attached to the subject, easy, exact identification of the subject is achieved, which avoids misidentification of subjects.

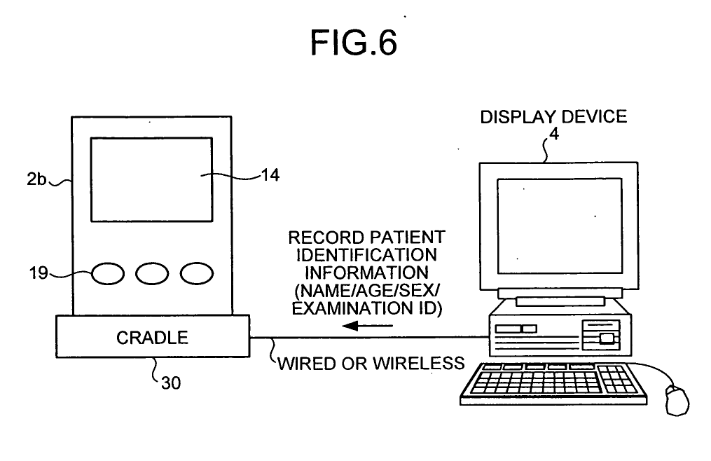

FIG. 6 shows another connection of the receiver and the display device which are both shown in FIG. 1. In FIG. 6, the external device 2b of the receiver 2 is placed on a cradle 30 and connected to the cradle 30 through an interface 18. The cradle 30 is electrically connected to the display device 4 through a wired or wireless connection and can transfer data between the external device 2b and the display device 4 in synchronization with them. The external device 2b also includes a hard disk drive serving as a internal storage medium as the memory 13 shown in FIG. 3. Accordingly, the external device 2b is placed on the cradle 30, and then the identification information from the display device 4 of the workstation is stored in the memory 13 of the external device 2b before the examination. The display device 4 may output an instruction information for setting the specific information to be displayed on the display unit 14 to the external device 2b.

The external device 2b is removed from the cradle 30 and then attached to the subject 1 to store data transmitted from the capsule endoscope 3 while the capsule endoscope 3 moves through the body cavity of the subject 1. After capturing body cavity image of the subject 1 is completed, the external device 2b is placed on the cradle 30 again so that the display device 4 reads out the data stored in the memory 13.

As described above, in this embodiment, the receiver is connected to the display device through the cradle to record identification information, and specific information is displayed on the receiver. Therefore, as in the first embodiment, when the receiver is attached to the subject, easy, exact identification of the subject is achieved, which avoids misidentification of subjects.

Further, in this embodiment, the specific information to be displayed on the receiver can be set in the display device. As a result, the setting of specific information becomes easy and the versatility of the device can be expanded, compared with that in the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receiver that is carried by a subject and receives a radio signal transmitted from a transmitter introduced into the subject, comprising:
an acquiring unit that acquires specific identification information of the subject;
a storage unit that stores the identification information acquired by the acquiring unit; and
a display unit that displays the identification information stored in the storage unit.

2. The receiver according to claim 1, wherein
the display unit displays at least identification items of name and age of the subject, of the identification information stored in the storage unit.

3. The receiver according to claim 1, wherein
the display unit displays at least an identification item of face of the subject, of the identification information stored in the storage unit.

4. The receiver according to claim 1, further comprising
a display control unit that controls the display unit to display a specific identification item of the identification information stored in the storage unit.

5. The receiver according to claim 4, wherein
the display control unit selects the specific identification item to be displayed on the display unit, based on an instruction by an external instruction device.

6. The receiver according to claim 4, further comprising
an instruction unit that sends an instruction for selecting the specific identification item, wherein
the display control unit selects the specific identification item to be displayed on the display unit, based on the instruction by the instruction unit.
